(19) United States
(12) Patent Application Publication
(10) Pub. No.: US 2014/0166559 A1
(43) Pub. Date: Jun. 19, 2014

(54) THREE-DIMENSIONAL FILAMENT MATRIX AS BIOLOGICAL FILTRATION MEDIUM

(71) Applicants: E. Craig Jowett, Rockwood (CA); Christopher Richard James, Grand Valley (CA)

(72) Inventors: E. Craig Jowett, Rockwood (CA); Christopher Richard James, Grand Valley (CA)

(73) Assignee: ROWANWOOD IP INC., Rockwood (CA)

(21) Appl. No.: 14/132,476

(22) Filed: Dec. 18, 2013

(30) Foreign Application Priority Data
Dec. 18, 2012 (GB) 1222863.1

(51) Int. Cl. C02F 3/10; C02F 3/28

(52) U.S. Cl. CPC C02F 3/101; C02F 3/2806
USPC 210/150

(57) ABSTRACT

A microbial attachment means with consistent physical properties and non-degradable material suitable for submerged or free-draining filtration of wastewater is provided in the present invention. The material is used in the construction and landscaping industries and is readily available and cost-effective. It consists of a web or mesh of loosely overlapping polymeric filaments forming sheets with small three-dimensional topographic undulations or “hill and valley”, corrugated morphology. The sheets are configured into a variety of shapes that form an isometric matrix of irregular filaments as protected surface area for microbial attachment, and with intervening large pores for water and air circulation.

This technology relates to microbiological water treatment, in which contaminated wastewater is conducted through a body of media material, being material upon which viable colonies of microbes have become established, of the kind that generate redox transformation reactions in the contaminating substances. The treatment can be done anaerobically, for example in order to procure the anaerobic reduction of nitrate to nitrogen gas, diminution of BOD, and so on—or aerobically, for example in order to procure oxidation of ammonium to nitrate, and diminution of BOD.

It is not unknown for such microbe-assisted reactions to be triggered naturally—for example, in engineered water drainage facilities—under certain conditions. The present technology is distinguished from such incidental (or accidental) reactions, in that in the new technology the reactions are procured in a water-treatment-station.

Herein, a “water-treatment-station” is a purposefully-coordinated deliberately-engineered apparatus or installation that includes a water-inlet-port, through which contaminated wastewater—especially water contaminated with sewage—is received; the apparatus includes also a water-outlet-port, through which the now-treated water is discharged—e.g into the ground, or into a lake, stream, etc, or into another station for further treatment.

The water-treatment-station contains a body of treatment media material through which the contaminated water is conveyed. The station can include a powered pump for moving the to-be-treated water through the station, or the required movement of water can be effected by gravity. The station can be structured to include facility for enabling a throughflow of air relative to the media material, or to include facility for ensuring air cannot reach the media material.

It is not a required characteristic of a water-treatment-station that the water discharged from the station is clean enough to be released into the environment. The discharged water might be conveyed to another station for further treatment, for example.

An apparatus or installation is not a water-treatment-station, as that term is used herein, unless the apparatus or installation includes a water-inlet-port through which contaminated wastewater is received, and a water-outlet-port through which the now-treated water is discharged. An apparatus or installation is not a water-treatment-station unless it includes a container or housing of such structure that water cannot enter or leave the station except via those ports.

Usually, the contaminated water will be sewage water, from a residence or other occupied building, or from a group of same. However, water or wastewater is “contaminated”, for present purposes, if the water contains substances in suspension, in solution, etc, at such concentrations that those substances must be diminished to acceptable levels, or removed, before the water can be released into the environment. Water in which such substances are present only at negligibly-small concentrations is not “contaminated” water, for present purposes. Water in which the only substances present are substances that cannot be transformed by microbe-assisted redox reactions is not “contaminated”, as that term is used herein.

The new technology involves the use of a herein-defined material, and form of material, as the media material in a water-treatment-station. The material itself is known, per se. In the new technology, the known material is put to new use as a microbe-attachment material. That is to say: the known material is now put to new use as the media material upon which the microbe colonies required for the redox transformation reactions can and do become established.

Some of the characteristics of the known material will now be described, with reference to the accompanying drawings.

The attached FIGS. 1,2,3,4 are photographs of an example of the known material, which is suitable for present purposes.

FIG. 1 is a photograph of a piece of an open-network sheet that has been formed into a corrugated three-dimensional layer of matting.

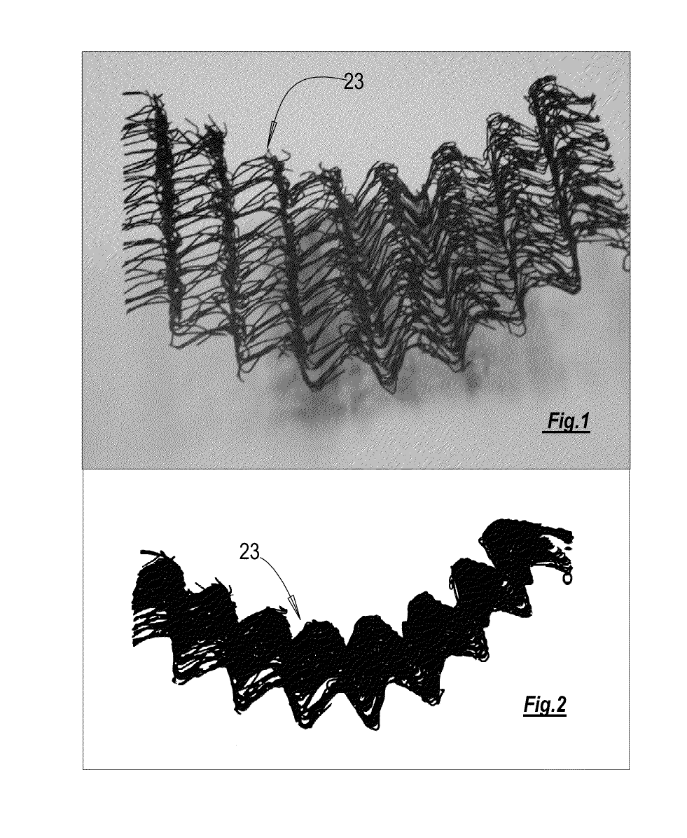

FIG. 2 is a scanned photograph of the same piece of matting, taken from the edge, to illustrate the corrugated configuration.

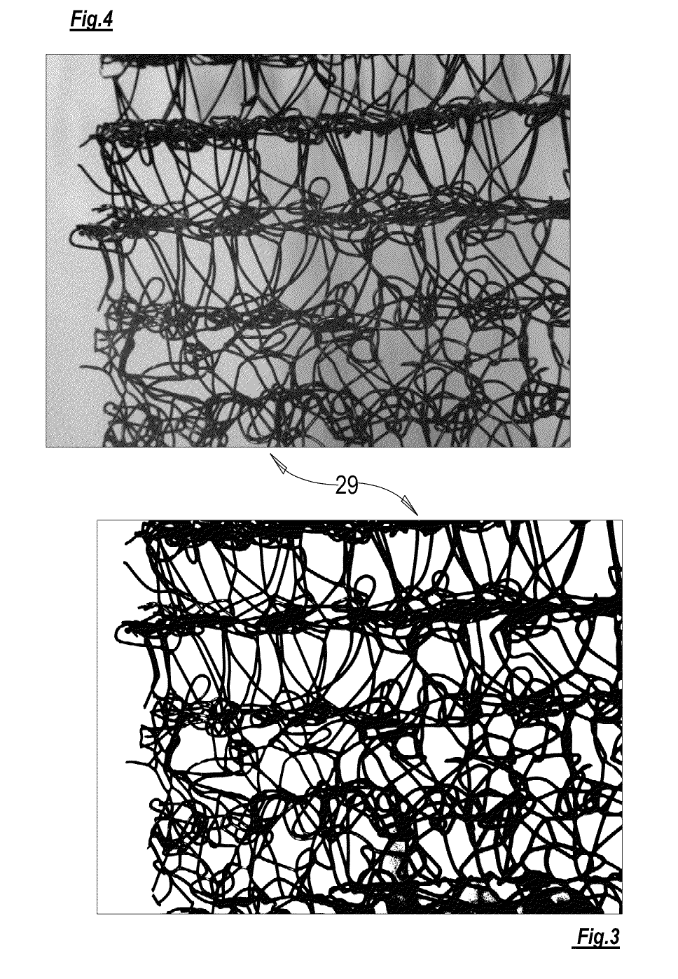

FIG. 3 is a close-up photograph of a portion of the piece, the corrugations having been smoothed out to illustrate the open network of the sheet.

FIG. 4 is a scan of the photograph of FIG. 3, and illustrates the contrast between the filament fibres and the open spaces of the open network of the sheet.

FIG. 1 shows a piece of a layer 23 of three-dimensional matting. The matting was formed from a two-dimensional sheet formed as an open network of plastic (e.g nylon, polyethylene) filaments. The actual piece as shown in FIG. 1 was twelve centimetres (left-right) by eight cm (front-back). The piece was of corrugated form, as illustrated, having eight ridges and seven furrows, the corrugations being pitched every 1.5 cm across the layer. The layer 23 had a ridge-to-furrow overall thickness of one cm.

In FIG. 2, although the layer of matting appears to be impenetrable in this photograph, it will be understood that water can pass through the mat, not only in the through-the-thickness direction, but also in the in/out-of-the-paper direction, substantially equally, without any resistance from the matting to that movement.

The visual appearance of the two-dimensional sheet, as shown in FIGS. 3,4, is that of an inextricable tangle of fibres—but still, the sheet clearly is an open network. It will be perceived that the many fibres that make up the open network were actually derived from a small number of extruded filaments, continuously looped and overlaid many times to form the sheet.

The fibres in FIGS. 1,2,3,4 were 0.50 mm in diameter. All the fibres were the same diameter. The material of the fibres was polyethylene. The surfaces of the fibres were smooth and shiny.

The FIG. 3,4 sheet can be characterized as a network of such openness that water can flow through the network more or less without resistance.

FIG. 4 is a scan of the photograph of FIG. 3. It can be regarded that FIG. 4 represents the image on a screen when light is projected through the two-dimensional sheet. In FIG. 4, the area occupied by the fibres (black) can be contrasted with the area occupied by the open spaces between the fibres (white), and those respective areas, and the ratio between them, can be measured, as a characteristic of the particular sheet, or of that piece of the sheet. In the example shown in FIG. 4, the (black) fibres occupy just about twenty percent of the area of the projection, and the (white) open spaces eighty percent.

It will be understood from FIGS. 3,4 that the tangle of fibres is more concentrated in the furrows than over the peaks and in the sides of the corrugations. This is as a result of the way in which the matting is manufactured. The above area percentage figures refer to the sheet as a whole—the percentage as measured over a small area could be quite different. The 80/20 area ratio was more or less uniform, furrow to furrow.

The layer 23 of matting was formed, during manufacture, into the corrugated shape, which was made permanent in that the plastic was allowed to cure in that shape. The corrugated layers of matting are flat, except that the matting is usually sold and shipped in coils, and the matting can take on the curvature of the coils—as can be seen in FIGS. 1,2.

Some previous uses of the known material will now be described.

The known material (as shown in FIGS. 1,2,3,4) traditionally was employed in connection with water-related systems, especially in-ground water systems. Its main usage has been as a spacing layer between two low-permeability surfaces, to enable/permit water or moisture, or moisture-laden air, to pass freely along between the surfaces. Thus, the described material (or a close variant thereof) has been used as a separating layer to separate the outer surface of a concrete basement wall from the surrounding ground. The material has also traditionally been used as a separating layer to hold roofing shingles separate from the roofing felt—in which usage, again, the layer serves to permit movement of air, water, or moisture, to enable the shingles to dry out.

The known material as shown in FIGS. 1,2,3,4 is sold under the registered trademark CEDARBREATHER. This material is suitable for use in the technology that is the subject of this specification. A variant that is also suitable is sold under the trademark ENKADRAIN9120.

The new technology will now be further described with reference to the accompanying drawings, in which:

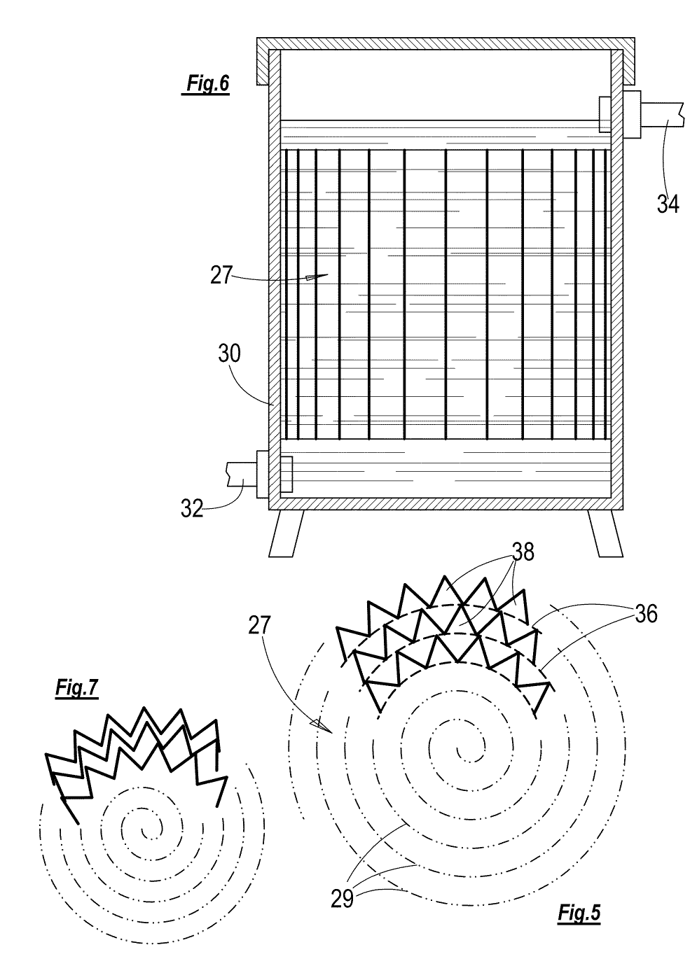

FIG. 5 is a diagram depicting a long length of the matting of FIG. 1, which has been rolled into a spiral body of treatment material.

FIG. 6 is a sectioned side elevation of a water treatment station, in which the spiral roll of matting of FIG. 5 has been placed inside a right-cylindrical housing.

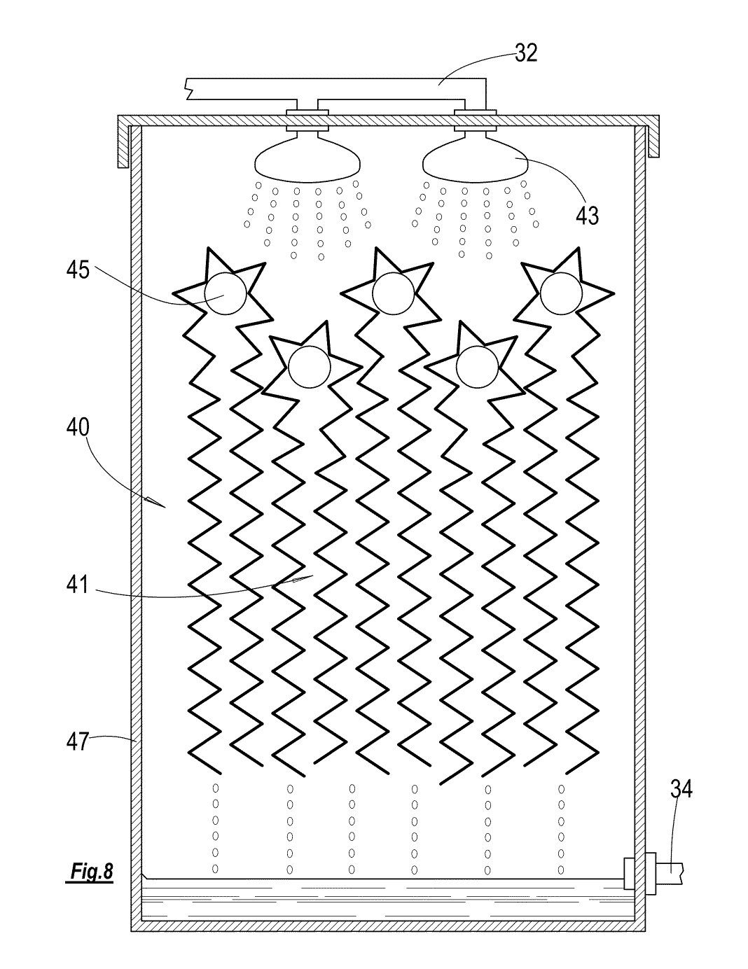

FIG. 7 is a similar diagram to FIG. 5, in which the same layer of matting has been rolled into a tighter spiral.

FIG. 8 is a sectioned side elevation of another water treatment station, in which the layers of matting are arranged in an aerobic environment.

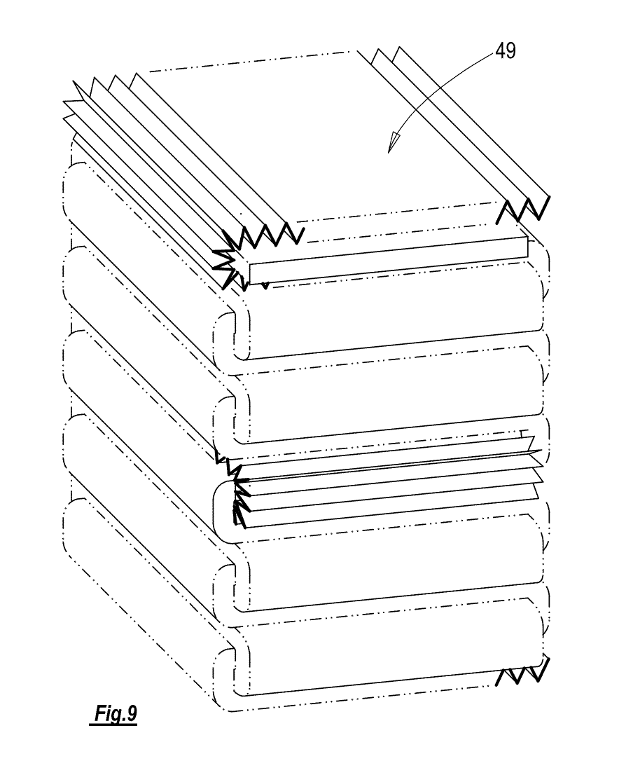

FIG. 9 is a diagram showing another way in which the layers of matting can be arranged.

FIG. 10 is a photograph showing another way of arranging the matting.

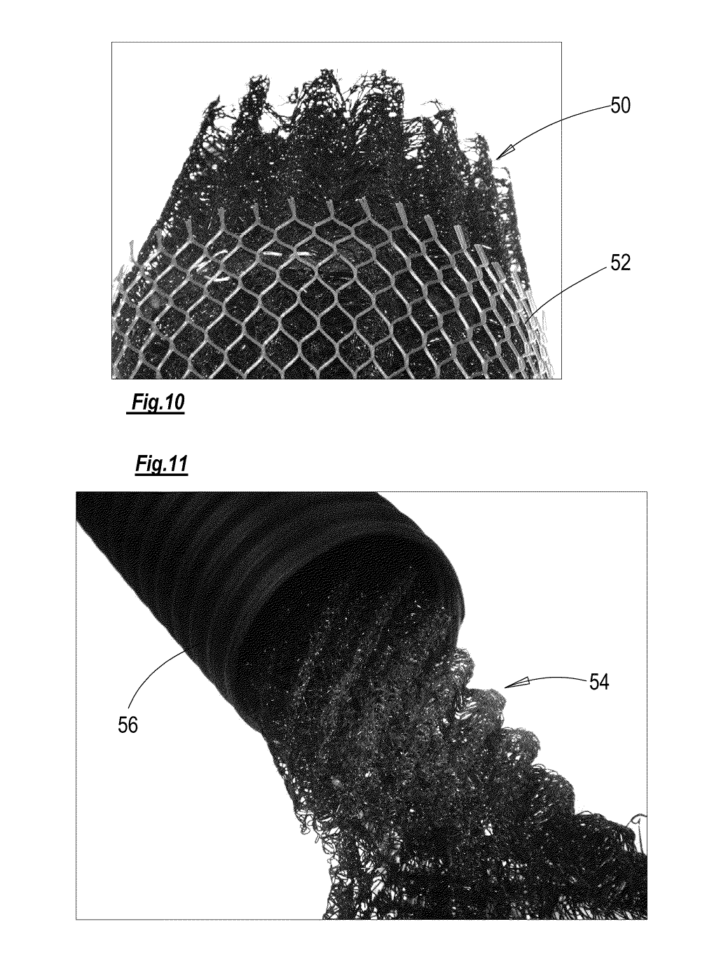

FIG. 11 is a photograph showing yet another way of arranging the matting in relation to the housing.

In FIG. 5, a length of matting has been rolled into a spirally-rolled body 27 comprising several turns or layers 29. As shown in FIG. 6, the spiral roll 27 of layers 29 of matting is placed inside a right-cylindrical housing 30. The roll 27 is so sized and arranged that, when placed in the housing 30, the outer layer 29 of the roll 27 presses resiliently against the cylindrical walls of the housing 30, and so that the whole roll 27 is under such compression that each of the layers 29 is in compression, whereby the roll 27 stands as a unitary mechanical structure. Typically, the length or height of the roll is twice the diameter of the roll.

Contaminated water (e.g sewage water from a building, or from a group of buildings) enters the housing 30 via a water-inlet-port 32, and exits through a water-outlet-port 34. During treatment, the water travels upwards through the roll 27. Thus, the roll 27 remains submerged (whereby oxygen is excluded) during operation of the water-treatment-station. FIG. 5 shows the station configured for anaerobic treatment; the station can be configured for aerobic treatment e.g by bubbling air mechanically through the roll 27, from the bottom to the top.

FIG. 5 is a diagrammatic plan view of the roll 27, showing the (triangular) open passageways 36 through the roll, as created by the corrugated layers 29.

In FIG. 5, a divider 38 has been provided, made of open plastic mesh, the cords of the mesh being pitched e.g one cm apart. The mesh divider 38 has been rolled in with, i.e between, the layers 29 of matting.

The ridges and furrows that make up the corrugations that make up one of the spiral layers 29, though of the same linear pitch (the ridges repeat e.g every 18 mm) as those of the adjacent layers, of course are of different angular pitch. Thus, e.g four ridges of an inner layer face five furrows of the next outer adjacent layer. The ridges and furrows of one layer match and mismatch those of the adjacent layers a number of times repeatedly around the circumferences of the layers.

In FIG. 7, the divider 38 has been omitted. Therefore, now, where the ridges and furrows match, the ridge will enter the furrow and the layers will close together. Where the layers lie ridge-to-ridge, the ridges are held apart. The effect is that, in FIG. 7, the layers do not follow the smoothly increasing radius indicated in FIG. 5. In FIG. 7, where a ridge of the inner layer coincides with a furrow of the outer layer, the two layers nestle and lie much closer together. In FIG. 7, the large triangular passageways 36 shown in FIG. 5 are present only over certain sectors of the layers; over the other sectors, the layers nestle into each other, and the triangular passageways are (partially) closed up.

If the designers wish the corrugated layers 29 to be closer together, they should omit the divider 38. The divider 38 being present in FIG. 5, here the layers are the turns of a smooth regular spiral, and the layers remain evenly spaced, and well spaced, from each other over all the sectors, and all the triangular passageways 36 are open. The structure of the divider 38 should be such as to (a) mechanically prevent the ridge of one layer entering the furrow of the adjacent layer, and (b) offer zero resistance to the passage of water through the divider, whereby water in the housing can move freely in all directions through the roll.

FIG. 8 shows an aerobic trickle water-treatment-station 40, which also makes use of the layers 29 of corrugated matting as described. Water to be treated enters the station through the water-inlet-port 32 and is conveyed away via the water-outlet-port 34. The incoming water sprays down onto the body 41 of treatment media material through nozzles 43.

Alternatively, the roll 27 of FIG. 6 can be used in the aerobic trickle-filter configuration of FIG. 8. In that case, the designer can choose a tightly wound roll (FIG. 7) for weaker wastewater, or a loosely wound roll (FIG. 5) for stronger wastewater. The shape of the housing of the water-treatment-station should be tailored to the shape of the body of treatment media material; if there is a chance that the to-be-treated water might bypass the body by passing between the body and the walls of the housing, the body should be made a tight fit against the walls.

In FIG. 8, the layers 29 of corrugated mat are draped over support-rods 45, which are fixed to the housing 47 of the station 40. The support-rods 45 are arranged so that the layers 29 are touching, or almost touching. It can be arranged that the outermost layers of matting make contact with the side-walls of the housing 47, or the layers can be free of the walls. The important thing is that the designers should position the support rods and the nozzles so that all the drops of contaminated water that pass through the nozzles 43 will trickle down through the layers 29 of treatment material, i.e so that no drops can bypass the treatment media material.

In a variant (not shown), further support rods are provided near the bottom of the housing. Now, a continuous length of matting is looped over the left-most top rod, then down and under the left-most bottom rod, then up over the next top rod, then the next bottom rod, and so on, such that all the several layers are formed from one long length of matting. This can make for easier assembly of the matting into the desired configuration.

The matting is flexible in that the matting can be bent (e.g by hand manipulation) around the support rods as shown in FIG. 8. However, the matting is recalcitrant in that it tends to return to its as-manufactured configuration. Designers should recognize the desirability of providing constraints that hold the matting in its desired configuration. The rolled-in-a-spiral-coil configuration (FIGS. 5,7) presents probably the least problem as regards constraining the layers of matting into their desired configurations.

FIG. 9 is a pictorial diagrammatic view of another body 49 of media material comprising layers 29 of media material. In FIG. 9, the media material again comprises the corrugated matting composed of filament fibres, as shown in FIGS. 1-4. In FIG. 9, the body 49 is made from two lengths of corrugated matting, intercalated with each other, as shown, to form N layers. In FIG. 9, N is twenty-four. The widths of the two lengths of matting, and the number of layers, is determined by the dimensions of the housing, and of course is dictated by the quantity of wastewater and the strength of the contaminants that are to be removed.

In a variant of FIG. 9 (not shown), the N layers are made up as N separate pieces of corrugated matting.

The configuration illustrated in FIG. 9 can be used in both the submerged (FIG. 6) and the aerated free-draining (FIG. 8) water-treatment-stations.

In FIG. 9, the layers can only touch each other ridge-to-ridge (and not ridge-to-furrow) because the corrugations in one layer lie at right angles to the corrugations of the immediately adjacent layers. Thus, the triangular water-conducting passageways, in FIG. 9, through and between the layers 29 are highly uniform—as they are in FIG. 5, but in FIG. 9 there is no need for the dividers 38 to make them so.

It will be understood, in FIG. 9, that the water undergoing treatment passes vertically (upwards or downwards) through the body 49, i.e at right angles to the planes of the layers 29. In FIGS. 6,8, by contrast, the water passes lengthwise along and parallel to the planes of the layers 29.

In FIG. 9, as in FIG. 8, the configuration of the layers lends itself to the housing being cuboid (square or rectangular). This is beneficial in that the body of treatment material can easily be custom-fitted to the shape/size of an existing tank, which are commonly available in concrete or metal. In FIGS. 5,7, by contrast, the rolled spiral configuration of the layers lends itself to the housing being cylindrical—round tanks and pipes being commonly available in HDPE plastic or fibreglass.

The FIG. 6 water-treatment-station is set up for submerged anaerobic water treatment. However, the FIG. 6 station could be used for free-draining aerobic water treatment if the water inlet and outlet were reversed, and if provision were made for aerating the media material (e.g by blowing air through the media material). Similarly, the FIG. 8 station could be adapted for anaerobic treatment, again by reversing the inlet and outlet, and now by excluding oxygen from the treatment media.

FIG. 10 shows a body 50 of media material comprising several layers of corrugated matting, rolled into a spiral coil. The coil is physically constrained and confined by being placed inside a sleeve 52 made of plastic mesh. Confining the coil in this way makes it easier to handle, and easier to assemble into a cylindrical housing.

FIG. 11 shows another way of placing a body 54 of corrugated matting inside a cylindrical pipe 56. Here, the matting is cut into a long strip, having a width a little greater than the (internal) diameter of the pipe 56. The long strip is folded, e.g twice, thereby creating the body 54 as a body of three layers, one third the length of the strip. The ends of the three-layers-thick body 54 are twisted relatively, to form a helix. FIG. 11 illustrates the helical form of the body 54, protruding from the end of the pipe 56.

To assemble the helical body 54 into the pipe, one end of the three-layers-thick helix is fed into the mouth of the pipe; that end is then twisted in the direction to increase the helix angle, thereby reducing the overall diameter of the helix. In this way, the helix can easily be pulled into and through the pipe progressively lengthwise along the length of the pipe, to the required length. Once the helix has been fed into the pipe, the twist can be released, whereby the helix expands outwards into contact with the walls of the pipe.

In FIG. 11, by suitable selection of the dimensions and folds of the strip of matting, the helix can be made to fill the pipe to create the desired level of open spaces inside the pipe. Done properly, the assembled helix fills the tube with a uniform distribution of pore-spaces. The helix is easy to assemble into the pipe upon twisting the helix, and yet the helix remains fixed firmly in position when the twist is released.

Typically, the pipe 56 is placed inside a treatment tank or vessel of an overall treatment station, where it serves to concentrate the treatment of the contaminant—in cases, for example, where the tank or vessel is being called upon to cope with a more difficult wastewater than the original designers had in mind.

In the above-described embodiments (FIGS. 5-11), the resistance to waterflow offered by the body of layers of matting is negligible. The resistance to the flow of water provided by the layers of matting might or would increase if the velocity of the waterflow were to be increased—but in a water treatment station the velocity of the water with respect to the media is not high. The velocity is slow enough to give a good residence time, and is slow enough to avoid dislodging the microbes from the media material, and, at these low velocities, the resistance to waterflow offered by the matting, to flow in all directions, is practically zero.

It will be understood, from the structure of the bodies of media material—made up of layers of open network matting—that waterflow along the plane of the layers is substantially unimpeded by the presence of the body, and equally, that waterflow at right angles to the plane of the layers also is substantially unimpeded. In FIGS. 6,8 the shortest active flowpath of the water through the body is along the planes of the layers; in FIG. 9, the shortest active flowpath is at right angles to the planes of the layers. In FIG. 11, the shortest active flowpath is at the helix angle with respect to the planes of the layers.

In the present technology, the resistance to waterflow attributable to the presence of the body of media material—though not zero—is negligible. That is to say: the flow resistance provided by the body of layers of matting is practically and substantially zero in the conditions in a water treatment station. (It may be noted that some traditional media materials offer an all-too-significant resistance to waterflow).

The hydraulic pressure head that is required in order to make the water flow through the housing, insofar as the head with the body present is different from the head with the body absent, is different only to an insignificant extent.

It is possible, in the present technology, that the resistance to flow offered by the body of media material might increase, and might become substantial and non-negligible, due to a build-up of created substances residuating from the water treatment, such as slime, within the pores of the open network of filament fibres in the body of media material. The designers should make provision, in case of such build-up, for back-flushing (or forward-flushing) the body of media material, to physically remove the slime.

It might be considered that the wide-open, very high-porosity body of treatment material might allow a drop of water to pass through the body substantially without making contact with fibres of the matting, and thus without making contact with the microbes residing on the fibres. However, within the described parameters, this substantially does not happen.

A drop of water passing (slowly) through the media material, upon striking one of the fibres, acquires a (small) velocity vector at right angles to the direction of flow. This lateral vector is repeated and reversed many times as the water travels from water-entry to water-exit. These small, though frequent, small deflections of the drops tend to stir and mix the water as it passes through the body, and to ensure that each drop comes into contact with a large number of the fibres (and a large number of microbes). The fact that the fibres are aligned as if inextricably tangled, and the fact that the high-porosity media material is wide open to unimpeded waterflow in all directions, are important in stirring and mixing the water as it travels along. The point can be made that well-mixed water is more-readily-treatable water.

There is very little tendency for fingers of lowered flow-resistance to become established in the body of media material, in that the media material already has (virtually) zero resistance to waterflow in all directions.

The layers of corrugated matting, as described herein, sometimes are sold with a fabric backing, which, though not completely impermeable to waterflow, does have a significant flow-resistance. If the body of media material is formed from layers of such corrugated material, i.e from layers to which a significantly-impervious backing is attached, that would not be preferred. The backing would prevent or impede the passing water from being deflected laterally, and thus from being stirred and mixed to anything like the beneficial extent that occurs when the body of material is wide open to waterflow in all directions. (Note that, in FIG. 5, by contrast, the dividers 38 are of wide-open mesh, and provide zero flow resistance.)

Thus, the fact that water is able to pass through the open spaces of the body without significant resistance to flow, coupled with the presence of the fibres aligned as if thoroughly tangled, means that the water is stirred and mixed as it wends its way through the fibres, and means that every drop of water spends a good percentage of its in-the-body residence time, in very close proximity to the fibres, and to the viable colonies of microbes that are established on the fibres.

It is recognized that the material of FIGS. 1,2,3,4 is highly suitable for use in a water-treatment-station—from the physical or mechanical standpoint, as well as from the standpoint of the beneficial effects of the tangled-alignment of the fibres on the flowing water.

Most plastic materials are subject to dimensional creep. If plastic material is distorted (bent, twisted, stretched, etc) the alignment of the molecules of the material changes, over a period of time, in such manner as to shed some or all of the stresses causing the distortion; over a period of time, the material sets permanently to the new configuration, i.e to the distorted shape/size; then, if the stresses causing the distortion are later removed, the material does not revert back to its original shape/size—either not at all or not completely. In FIGS. 1,2, the piece of matting is curved because it was cut from a length of matting that had been shipped and stored in a roll, and the piece of matting had taken on the imposed curvature as a semi-permanent set.

Thus, in FIG. 8, for example, or FIG. 9, the matting can be expected, over a period of e.g weeks, to start to take on the shape/size into which it has been forced. However, in its short residence in the workshop in which the water-treatment-station is manufactured, the matting, though flexible and resilient enough to be distorted to the indicated shape/size without damage, would tend to spring back to its original shape if the distorted shape/size were released. Therefore, the designers should provide constraints to hold the material in its distorted shape/size.

When the known material is used as the microbe-attachment media material in a redox-transformation-producing water-treatment-station, in the present technology, certain benefits arise. In the present technology, the body of media material is in the form of several layers of corrugated matting, assembled layer-to-layer. In the technology, water can pass freely in all directions. One reason why this is beneficial, as explained, is that it ensures that the water is thoroughly mixed and stirred as it passes through the body of media material.

Another reason why it is beneficial for the body of media material to have the capability to enable/permit flow laterally in all directions may be explained as follows. Sometimes, a blockage can occur at a particular point in the body of media material. This might arise due to a local build-up of excess slime, for example. If the body of media material were such that lateral flow around the blockage was blocked, or partially blocked, the effect of the blockage would be magnified, and likely the blockage would become worse, by positive feedback. But if there is zero resistance to lateral flow, now the flow can deviate laterally and can simply pass around the blockage. The blockage will not then serve as a focus for further blockage.

In the new technology, the body of microbe-attachment material is formed as several layers of matting. The layer of matting is formed from a basically two-dimensional sheet which comprises an open network of filament fibres. The layer of matting is considerably thicker than the thickness of the sheet, in that, in the layer of matting, the sheet has been formed into corrugations. Thus, the three-dimensional layer of matting comprises the corrugated sheet.

The sheet can be characterized as a network of such openness that water can flow through the network more or less without resistance. At the same time, the tangle of fibres provides a considerable surface area of the solid (plastic) material of the fibres, and the tangle provides many nooks and crannies and tight corners, where the fibres contact and overlie each other. These serve as mechanical anchors, whereby the microbe colonies can become firmly attached to the sheet.

It is recognized in the present technology that the known material is highly suitable for another use, i.e as an attachment-medium for establishing and supporting viable colonies of microbes; in particular, microbes of the kind that are able to generate redox transformation reactions. Such microbiological reactions are effective to procure e.g anaerobic reduction of nitrate to nitrogen gas, aerobic oxidation of ammonia to nitrate, diminution of BOD contaminants, and other forms of water treatment.

The layers of matting are very versatile as to how they can be used to create microbiological treatment material. In the area of water treatment equipment for applications where there is no access to mains sewage disposal, a water-treatment-station can be designed and manufactured to suit more or less any particular case, and whatever the specific application requires by way of the reactions to be engineered, and whatever the required size and throughput, the systems-designers can simply resort to their stock of rolls of layers of corrugated two-dimensional sheets made from tangled plastic filaments. Always using that same stock, bodies of microbe-attachment treatment material can be produced in a huge range of sizes and applications in the small-installations water-treatment industry. The material is inexpensive, and is readily available on a proprietary-brand basis.

The new technology recognizes the benefits of using the known old material in a water-treatment-station. The new technology recognizes how easy it is to configure the old corrugated layers into a body of media material comprising several layers together.

In respect of the whole body of media material, in the water-treatment-station, the body is located in the housing such that water entering the station through the water-inlet-port enters the body of media material at a water-entry point of the body. Water having been treated leaves the body from a water-exit of the body, and is then conducted to the water-outlet-port of the station.

The body of media material is made up several layers of corrugated matting. The layers can be so arranged in the housing that the water being treated flows in-parallel lengthwise along the lengths of the layers (e.g FIGS. 6,8), or the layers can be arranged in a stack such that water passes thickness-wise through a first one of the several layers, then in-series through the thickness of a second one of the layers, and so on (e.g FIG. 9).

The layers of corrugated matting are inherently wide open and highly porous, to the extent that resistance to flow, in all directions through the body, can be regarded as zero or negligible. The body should be arranged in the housing and in the station as a whole such that nothing interferes with the inherent openness and lack of resistance to waterflow.

The corrugated configuration of the layer of matting can be defined, at least partly, by its compressive mechanical strength, as a layer. The three-dimensional corrugated shape of the layer of matting is permanently set into the filament fibres that make up the layer of matting, as a consequence of its manner of manufacture. Thus, when the layer is e.g placed between two boards, and the boards are pressed together, the layer of matting should retain its as-manufactured corrugated shape. The corrugations should not be significantly flattened out, nor become significantly more pronounced—within limits.

In the case of corrugated matting having an overall unstressed peak-to-trough height PT-0: the height PT-15 of the matting is the resulting height when the mat is compressed at an even pressure of fifteen kN/sq. m (=2 psi). PT-15 should be at least 60% of PT-0; below that, the mat might be too flimsy, in that the possibility might arise of the corrugations collapsing in local areas within the water-treatment-station. The compressed height PT-15 should be less than 90% of PT-0 however; above that, the layers of matting would be too stiff to be easily manipulated into new shapes, in the manner as described herein. (Pressure at 15 kN/sq. m occurs in the layer of matting, typically, when the layer is laid on the ground, and a 30 cm-square board is placed on the layer, and a man stands on the board.) When the pressure is released, after a minute or two, the mat should return resiliently to the full height PT-0.

In respect of the layer of corrugated matting, the layer is preferably between one cm and three cm in overall thickness. The corrugations preferably are in regular equispaced V-shaped troughs and ridges, as shown in the drawings, or the corrugations can have the form of those in e.g an egg-carton, where the up-promontories and the down-promontories are individual pyramidal or conical (or frusto-conical) in form, rather than elongate troughs and ridges that extend over the whole width of the as-manufactured matting. The actual form of the corrugations is less important than that the layer as a whole should have the mechanical strength to remain as a wide open network, and not collapse under the loads to which it is subjected during (a) manipulation of the layers into the several layers that make up the body of media material, (b) assembly of same into the housing, and (c) during operational use.

The layer of corrugated matting as shown in the drawings is formed from a sheet of filaments having a diameter Dia-F, preferably between 0.3 mm and 0.8 mm. The filaments are extruded (as a liquid or quasi-liquid) through nozzles, and deposited onto a corrugated mould. Typically, the filament, as it pays out, doubles and loops over itself in a circuitous, disordered manner. Where the filament thread makes contact with itself, the portions of the filament adhere together. Thus, the sheet has the appearance of an inextricable tangle of threads. The sheet becomes corrugated during manufacture, in that the plastic of the filaments sets and cures while residing in the corrugated shape of the mould.

It is not essential that the filament fibres be of circular cross-section: if not, the dimension Dia-F is the average of the major and minor dimensions of the filament. If the filament fibres are of plural diameters, the said limitations on the Dia-F dimension preferably apply to all the diameters.

The material of the filament should be inert, and should not release toxic substances into the water. Preferably, the material should also not absorb water, or at least should not do so in a quantity that causes the filament to expand, and thereby causes the layer of matting to lose its shape. However, the filaments being able to absorb or adsorb water (rather than repelling water), that could be advantageous in that the microbe colonies would likely be more securely attached to filaments that absorb water.

The filament fibres preferably should be of such material, and of such dimensions, that the (cured) fibres are flexible, being able to be bent and twisted unbreakably. Preferably, the filament has the capability to be greatly distorted (e.g by manipulation with the fingers) and yet the filament will return resiliently to its as-manufactured configuration (within limits).

The term “sheet” refers to the basically two dimensional sheet, comprising the filament matrix created by the criss-crossing of the filament fibres, which encircle and define the large open spaces. The layer of corrugated matting refers to the basically three-dimensional structure in which the sheet has been formed into corrugations, i.e shapes that have depth. The corrugations etc do not need to be in regular straight rows, but it is convenient to make them so.

The liquid filament thread sets and solidifies and cures, in whatever pattern results from the particular manner in which the liquid thread was deposited on the mould. In the drawings, the fibres have the appearance of an inextricable tangle, but that is not essential—the placement of the filaments could be done in a more regular manner, for example. However, the colonies of microbes need to attach themselves to the fibres, and that attachment is made easier—given that the fibres form a highly porous, wide open network—where the filament fibres are hugely tangled, i.e where there are many nooks and crannies into which the microbes can become established.

The openness of the sheet will now be described.

There is an open point, P-open, in the volume of the body of material. P-open is a point that is located within the three-dimensional layer of corrugated sheet material. P-open is in an open space between adjacent filament fibres. (There is an infinity of such open points in the layers of matting.) In respect of each open point P-open, there is a complementary point, P-fibre. P-fibre is the point in the matrix of filament fibres that is the closest point to the open point P-open, the point P-fibre being located actually upon one of the filament-fibres.

The length of the straight line joining P-open to P-fibre is termed LenON. The configuration of the water-conduit, in relation to the mat, preferably is such that LenOF is six mm or less. If LenOF were greater than that, the possibility might arise that the contaminants in the water might pass through the mat without coming close enough to the microbe colonies to be snagged out of the water. Also, if LenOF were greater than six mm, the ability of the microbes to establish viable colonies in the matrix might be impaired.

On the other hand, the length LenOF preferably should not be smaller than two mm. Smaller than that, the tendency of the matting to become plugged or clogged might be too much. However, the extent to which the microbe colonies form bridges between adjacent filament fibres (and thereby clog the matrix) depends on more than the length LenOF, i.e whether the matrix will clog depends also on the operational treatment parameters (including temperature, etc), and on what contaminants are present, and the strength of the contaminants. With weaker contaminants, the length LenOf may be allowed to drop below two mm.

The sheet from which the layer of matting is made could be manufactured as a flat two-dimensional sheet, and then the sheet is laid over a corrugated mould, as two separate manufacturing operations. Once the matting has cured and has become permanently set into the three-dimensional corrugated form, the matting can then be rolled into a spiral, or otherwise configured into the body of treatment material as shown in the drawings, or yet otherwise again, and placed inside the housing.

Preferably, the corrugations that comprise the layers are V-shaped, and the passageways created by the corrugations are straight and of triangular cross-section (as shown in the drawings). However, these shape-characteristics of the layers and the passageways are incidental, rather than essential. The fact that the sheet and the layers and the passageways are open enough to provide practically-zero resistance to multi-directional waterflow is more important than that the passageways have a particular shape.

The preferred manner of making the open-network sheet from which the layers of matting are derived is by extruding the plastic filaments, as described. Alternatively, the open-network sheet can be made, for example, as an open-knit or open-weave sheet of plastic filaments, the three-dimensional corrugations being e.g impressed onto the knitted or woven sheet by moulding and curing. The filament fibres should be fused together, so that the resulting layer of corrugated matting is self-supporting.

The body of media material is housed in the housing. The points at which the to-be-treated water enters, and the treated water leaves, the body are the water-entry and water-exit points. The housing defines a conduit which guides and constrains the water to move through the body, from the water-entry to the water-exit. The housing also, as required, ensures that the water cannot bypass the body of media material.

Another dimension of relevance in defining the sheet of filament fibres, and of the three-dimensional layer of matting formed therefrom, is the path-length Len-Path. Len-Path is the length of the shortest path that a drop of contaminated water can take through the body, in travelling from the water-entry of the body to the water-exit. In some cases, the body is divided into a number of sub-bodies, with e.g plenum spaces between the sub-bodies, and in that case Len-Path is the aggregate of the sub-path-lengths of the sub-bodies; that is to say, the distance the water travels through the plenum spaces between the sub-bodies is not included when measuring Len-Path.

The length Len-Path of the shortest active flowpath through the body preferably should not be less than one metre for the aerobic trickle applications, and should not be less than fifty cm for the anaerobic submerged applications.

Reference is made herein to the term, “several” layers. In the case of the spiral roll (as in e.g FIGS. 5,7), the number of turns—and generally the number of layers—preferably should be at least five turns. Below that, the low capacity would indicate that the structure in question was something other than a purposefully-engineered treatment-station in which microbiological redox transformation reactions are performed on contaminated water.

The layer of matting being e.g 1.5 cm thick, seventeen turns or layers of the matting would be required in order to fill a cylindrical housing in the form of a pipe of e.g fifty cm diameter.

In most cases, the to-be-treated water is admitted into the housing in periodic doses. Between dosings, the water inside the housing is stationary. In the submerged configuration, during dosing, the just-admitted dose displaces the lowest water upwards, and so on progressively up the housing, such that the water discharged through the outlet-port, though of the same volume as the admitted dose, is water that has resided for a period inside the housing. The water has been in contact with the microbe colonies in the roll, during this residence time, and thus is properly treated.

A water-treatment-station in the submerged configuration may be fitted with an air diffuser below the body of media material, to effect an aerobic environment. In that case, the waterflow pathways through the media are more chaotic, being influenced by air bubbles. Designers should provide for this chaotic flowpath, e.g by using more loosely rolled media to enable air bubbles to pass through, or arranging for the water to pass through the media multiple times, to increase contact time.

Again, in the aerobic trickle-filter treatment station, generally the to-be-treated water will arrive at into the station in periodic doses. The layers will dry out, more or less, between dosings (which is common in trickle filters). The thickness of the corrugated matting, and the extent of the layers, and the other parameters of the system, should reflect the reduced media residence time of the trickle system, as compared with the up-flow configuration of FIG. 6.

Certain differences arise as to the most suitable form the known material should take, in the two cases of (a) submerged anaerobic treatment, and (b) free-draining aerobic treatment.

A reasonable working filament matrix for submerged use has a filament diameter of 0.3 mm to 0.8 mm, a sheet thickness of 10 mm to 15 mm, and an overall weight of filament fibres of 330 grams to 360 grams per square meter of the layer of matting For free-draining configuration, the thickness can be smaller, at 5 mm to 10 mm, and can have a denser packing of filaments in the matrix. The material is provided in rolls of 100 cm to 200 cm wide and 100 m to 200 m long, which can be re-configured into different shapes and densities according to its intended use.

As manufactured, a suitable filament sheet such as CEDAR BREATHER® in corrugated ridge & furrow morphology of 10 mm thickness (i.e 10 mm top of ridges to bottom of furrows). It has a filament diameter of 0.40 mm to 0.43 mm, which provides a filament surface area for microbial attachment of 1.9 sq. m to 2.0 sq. m of filament surface area per square metre of the layer of corrugated matting, or 8.1 sq. m to 8.7 sq. m per kilogram of matting.

Almost all the surface area is protected from physical removal of biomat in the preferred embodiments of rolled or folded sheets, or bagged scraps. During aeration with diffusers, air bubbles encounter the biomat and when too forceful, or during high hydraulic flows, the biomat internal to the matrix volume can be removed (i.e, backwashed), but during normal use, the agitation is insufficient to remove the biomat. In the smaller piece embodiment, the outside surfaces will be “unprotected” whereas still the great majority of the surface area will remain protected for more efficient use.

When rolled up loosely for submerged applications, the protected surface area of the filament matrix is 500 sq. m to 550 sq. m per cubic metre of the volume of the body of layers of matting—which is similar to that of sand and other proprietary media. The volume of the solid filament fibres occupies 5% to 6% of the bulk volume, leaving 94% to 95% open void space for air and water circulation—far greater than other proprietary media with similar surface area.

When rolled up more tightly for free-draining applications, the protected surface area is 725 sq. m to 775 sq. m per cubic metre of bulk volume—more than other proprietary solid media—and with the denser packing of solid matrix at 5% to 10% solid volume, still 90% to 95% of the bulk volume remains open as void space to permit free circulation of water or air.

The porosity is not only greater than most other media, but there are few to no restrictions between the pores that would plug up or otherwise prevent free passage of water or air. The pores are not spherical as in foam, have no narrow interstices or ‘throats’ as in sand or gravel, nor are they semi-isolated porosity as in foam or peat.

A comparison to buildings provides a good analogy. Filter sand can be likened to a building with large rooms made of solid quartz, with microbial attachment and water flow through very narrow passageways within the intervening wall-spaces between rooms. Open-cell foam can be likened to a building of large open rooms with microbial attachment on the walls and water circulation in the rooms and with good communication between rooms through large doors, but still with some restriction of flow within the medium piece from pore to pore.

The filament matrix medium in this invention is likened to a building without rooms or walls—having only a structural framework of curving columns (the filaments) —organized, somewhat randomly, throughout the empty building. Microbial attachment is on the outer surface of the filament columns and free water circulation is in any direction between the columns. There are no restrictive passageways within this building. With the porosity so high and being isometric or uniform in all directions, the filament matrix forms a superior attachment structure, compared to other media.

The sheets of filament webs are re-configured into matrix volumes of continuous filaments filling a volume controlled by the shape of the tank or container or by the application as detailed below. The tightness of the matrix is dependent on its use in either submerged (generally looser) or free-draining (generally tighter) environments, and on the general type of hydraulic and organic loading.

Another preferred method of forming the body of media material is to fit open-network sheets, such as scrap, into a mesh bag for submerged or free-draining use, being a cheaper apparatus and readily adapted to upgrading existing tanks or filters. In order for the wastewater to pass through the matrix volume without forming pathways, especially in submerged environments, the matrix volume should be as uniform as possible in the direction of the intended flow path.

Another preferred method is to form smaller matrix pieces in the shape of small cylindrical rolls, bow-ties, etc., of 10 g to 100 g weight. These are suited primarily for submerged environments with air diffusers agitating and tumbling the pieces around similar to Picobell® or Kaldnes® pieces. In this agitated environment, the pieces contact each other and the biomat formed on the outside of the piece is knocked off as aerobic sludge. A sludge management process is required in this case, whereas a body of media material in the form of a coil or roll can be backwashed when needed.

As mentioned, the layers of matting are formed as corrugations of a basically-two-dimensional sheet. The sheet is formed as an open network of filament fibres. It is convenient for the corrugations to be in the form of evenly-spaced regular uniform ridges and furrows, but the corrugations can also be irregular and disordered.

The body of treatment material comprises several layers of matting, and the water to be treated flows through the body. When the corrugations are regular and even, the layers of matting can be oriented to the shortest active flowpath along the corrugations, or at right angles to, or at a helix angle to, the corrugations; when the corrugations are disordered (as in the in-bag formation above), the orientation of the layers relative to the shortest active pathway can be a combination of any and all of these angles.

The notion of “protected” and “unprotected” surface area will now be described. With the rolled, folded or bagged filament matrix configurations nearly all of the surface area is protected against physical dislodgement of the microbes and associated treatment products, even with air diffusers below. With the small pieces configuration, the outer surfaces are unprotected during movement and agitation in submerged environments.

For up-flow aeration where air diffusers are positioned below the matrix volume, the filament sheeting can be thicker (e.g, 15 mm or more) so that greater pore size is available between the filaments for aerobic microbial sludge produced to fall out of the matrix more readily and be more readily back-washed, especially useful for wastewater with high-strength organics or fats and grease content.

A general guide for submerged applications is to attain a density of 50 kg to 70 kg per cu. m of the bulk volume of corrugated filament matting, which will provide 425 sq. m to 600 sq. m of protected microbial surface area per cu. m of the bulk volume, leaving 95% as open void space to allow easier backwashing and sloughing of aerobic solids.

The filament matrix can be used in a free-draining trickle filter environment, especially as a rougher filter on top of a finer grained filter such as foam, peat or sand. It can also be used in place of fine gravel or the like in a recirculating filter system.

In these cases, the filament sheets can be formed into a tighter formation to provide a more tortuous path, better distribution by cascading through the filaments, and increase residence time in the matrix. Sheeting can be rolled up for a round footprint matrix as for submerged environments and placed in a suitable container or basket.

The nature of the material as corrugated sheets and hill & valley morphology makes it difficult to tighten the roll beyond a certain density. Likely, 90% porosity is a reasonable lower limit for porosity or void space, but with care to nestle the furrows into the valleys as much as possible, higher densities with lower porosities could be made for specific wastewater applications.

A general guide for free-draining applications is to attain a density of 80 kg to 100 kg per cu. m of bulk volume of filament matrix, which provides 700 sq. m to 800 sq. m of protected microbial surface area, per cu. m of bulk volume of filament matrix, and still leave 92% as open void space to allow for efficient air circulation at the same time as water is moving downward.

In the configuration where sheets are draped over support bars, the sheets should be assembled so that they touch or almost touch most of the time so that there is no possibility of short-circuiting of untreated effluent from the top to the bottom.

As a rougher filter, an easy method is to lay sheets of the filament web on top of a more absorbent filter medium such as foam or peat, or on a finer grained polishing sand filter. This method is suitable for retrofitting a biological filter with a rougher when the wastewater turns out to be higher strength or with more oils and greases than anticipated in the original design.

When scraps of filament mesh sheets are available, the mesh can be stuffed into open-mesh bags of suitable size to make a three-dimensional matrix as isometric in its permeability as possible. When loosely packed, these bags can be placed into a submerged wastewater volume, ideal for retrofitting into existing tankage, placed evenly in a free-draining trickle filter. This method is cheaper when scraps or recycled material can be used, and is very suitable for retrofitting systems that turn out to be overloaded with fats and greases or organics.

To fully utilize the volume of medium, it can be important to direct the flow of wastewater evenly throughout the filament matrix. One way to do this without using energy is to fill plastic tubing with the layers of corrugated matting as described in relation to FIG. 11, and to place the tubing in a tank with wastewater directed into the upper end. If a flexible coiled tube such as agricultural drain tile is used, it can be coiled around the bottom of a tank such as in a surge storage tank, and allow the influent wastewater to come in close contact with the filament matrix.

This method is adaptable to retrofitting of existing systems to increase the treatment capacity with minimal intrusion on the site, and does not impede on the function of a tank volume otherwise used only for storage and pumping. It is a very suitable method for mixing two wastewaters in intimate contact with the matrix, such as nitrified effluent and septic tank effluent to assist in denitrification.

The tube configuration is most suitable for submerged environments as in recirculation tanks or surge tanks, and the density of packing of the filament sheeting should be as loose as or even looser than the submerged up-flow systems described above, e.g to 30 kg to 60 kg per cu. m of the bulk volume of filament matrix. The smaller the diameter of the tube, and longer the tube length, the looser the density should be.

With smaller flows of more dilute wastewater and the need for denitrification, for instance, a smaller diameter pipe of 150 mm to 200 mm is suitable, with the density at 50 kg to 60 kg per cu. m of bulk volume of matrix. For larger, stronger flows where BOD is the target, a larger diameter pipe of 200 mm to 300 mm is suitable, with the density at 50 kg to 60 kg per cu. m of bulk volume. Pipes smaller than 150 mm can be used, but the maintenance frequency may be higher if very long or with higher strength wastewater.

Similar to other submerged filters, backwashing of the filament matrix can be performed by rapidly injecting air into a coarse bubble diffusion manifold located below the filament matrix. Whereas diffusers often produce finer bubbles for improved aeration, coarser bubbles, preferably augmented by increased hydraulic flow, physically remove excess biomat and trapped gases from the matrix, diminishing the potential for hydraulic short-circuiting.

A diffusion manifold suitable for backwashing is made of 25 mm to 50 mm PVC pipe typically in an octagonal shape when placed under a cylindrical matrix. Diffusion holes of 3 mm to 6 mm diameter are spaced along the length of the manifold. The manifold is connected to a compressed air line or to a suitable high-flow pump, a pump dedicated to backwashing or another pump in the treatment train. During backwashing, the solids are preferably collected and diverted into pre-treatment tanks such as septic tanks.

The numerals used in the attached drawings are summarized:
23 piece of matting
27 body of water-treatment media material, here a spiral roll of layers of matting
29 layer of matting
30 cylindrical housing
32 water-inlet-port of housing
34 water-outlet-port
36 triangular open passageways
38 divider (plastic mesh) between layers
40 (FIG. 8) aerobic trickle water-treatment-station
41 body of water-treatment media material
43 nozzle
45 support rods in the housing
47 housing
49 (FIG. 9) body of water-treatment media material
50 (FIG. 10) body of water-treatment media material
52 sleeve of mesh
54 (FIG. 11) body of water-treatment media material
56 pipe

The scope of the patent protection sought herein is defined by the accompanying claims. The apparatuses and procedures shown in the accompanying drawings and described herein are examples.

1. A water-treatment station for treating contaminated water, wherein:
the station includes a body of microbial-attachment water-treatment media material;
the station includes a housing;
the body of media material is contained within the housing;
a water-entry of the body is a point on the body at which contaminated water to be treated enters the body;
a water-exit of the body is a point on the body at which water having been treated leaves the body;
the housing creates and defines a water-conduit, along which water undergoing treatment is conveyed from the water-entry to the water-exit;
an active-flowpath of the body of media material is the path a drop of water takes in passing from the water-entry to the water-exit;
the body is formed as several layers of corrugated-matting;
the corrugated-matting is formed from a two-dimensional sheet;
the sheet is formed as an open network of filament fibres;
the sheet is formed into a three-dimensional configuration having peaks and hollows, thereby creating the corrugated-matting;
the filaments are of such density, diameter, arrangement, material, and manufacture, that peaks and hollows present in the matting are permanently built into, and retained in, the filaments, whereby, during use, the open network and the three-dimensional configuration are mechanically self-supporting;
the material of the filament fibres is:
(a) substantially inert with respect to the water undergoing treatment and to the contaminants in the water;
(b) such that contaminant-extracting microbes are able to attach to, and to establish viable colonies on, the filament fibres;
the body, comprising the several layers of matting, is of such open structure that the body presents no more than insignificant resistance within the body to waterflow along the active-flowpath.

2. As in claim 1, wherein the body, comprising the several layers of matting, is of such open structure that the body presents no more than insignificant resistance within the body to water-flow having a vector component at right angles to the active-flowpath.

3. As in claim 1, wherein:
the station includes viable colonies of microbes that have attached to and have become established on, the filament fibres and in the layers of matting;
the microbes are effective to procure redox breakdown reactions in respect of contaminants contained in wastewater passing through the body.

4. As in claim 1, wherein the sheet formed as an open network of filament fibres has been so manufactured as to have the appearance of an inextricable tangle of fibres.

5. As in claim 1, wherein, in the sheet formed as an open network of filament fibres, the fibres are adhered together in such manner that the open network of filament fibres has the appearance of an inextricable tangle of fibres.

6. As in claim 1, wherein:
the filament fibres are of diameter Dia-F;
Dia-F is 0.35 mm or larger;
Dia-F is 0.5 mm or smaller.

7. As in claim 1, wherein:
when a light shines through the sheet onto a screen, the projected area of fibres PA-F is the area on the screen that is in shadow, and the projected area of open spaces PA-OS is the area of the screen that is illuminated;
the extent of the projected area of an area of the sheet is Area-S;
PA-OS is seventy percent of Area-S, or more;
PA-F is twenty percent of the Area-OA, or less.

8. As in claim 1, wherein:
the filament fibres have respective external surfaces;
over an area Area-S of one of the layers of corrugated matting, the aggregate of all the surface areas of the external surfaces of the filament fibres is Surf-Area-FF;
Surf-Area-FF is potentially available for attachment of the microbe colonies;
Surf-Area-FF is one sq. m or more, per sq. m of Area-S; and
Surf-Area-FF is three sq. m or less, per sq. m of Area-S.

9. As in claim 1, wherein:
the layers of corrugated matting are formed into a coiled spiral roll;
the water-treatment-station is so arranged that water to be treated passes through the body predominantly parallel to the axis of the roll.

10. As in claim 1, wherein the flowpath of water through the layers of corrugated matting is predominantly parallel to the planes of the layers.

11. As in claim 1, wherein the flowpath of water through the layers of corrugated matting is predominantly at right angles to the planes of the layers.

12. As in claim 1, wherein the body comprising the several layers of corrugated matting, having been assembled into the housing, is mechanically self-supporting.

13. As in claim 1, wherein:
the layer of corrugated matting has thickness Th-M;
Th-M is ten mm or more; and
Th-M is twenty-five mm or less.

14. As in claim 1, wherein the housing is so structured and arranged, in relation to the body, that contaminated water undergoing treatment in the station substantially cannot bypass the body.

15. In a water-treatment-station, the use of layers of corrugated matting as habitat for viable colonies of microbes.
